(19) United States
(12) Patent Application Publication
(10) Pub. No.: US 2006/0116120 A1
(43) Pub. Date: Jun. 1, 2006

(54) Monitoring synchronisation of signal measurement reports

(76) Inventor: Michael Hurst, Edinburgh (GB)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 11/232,291

(22) Filed: Sep. 21, 2005

(30) Foreign Application Priority Data
Nov. 5, 2004 (GB) 0424474.5

(51) Int. Cl. H04B 17/00; H04Q 7/20

(52) U.S. Cl. 455/424; 455/67.11

(57) ABSTRACT

Synchronisation of signal measurement reports in a mobile communications system is monitored by monitoring signalling messages traversing a signalling link and containing measurement reports of signals exchanged by a base station and a mobile station, deriving from the measurement reports a first indication of reporting of a first operational parameter of the exchanged signals, deriving from the measurement reports a second indication of reporting of a second operational parameter of the exchanged signals, and comparing the first and second indications to determine whether signal measurement reports are synchronised.

This invention relates to methods and apparatus for monitoring synchronisation of signal measurement reports in mobile communications systems.

### BACKGROUND ART

In a Global System for Mobile Communication (GSM) mobile communications network, for example, an active mobile station (MS) makes repetitive signal level and bit error rate measurements on the “downlink” signal received from the serving cell base transceiver station (BTS). These are transmitted to the BTS over the RF “air interface” using the Slow Associated Control Channel (SACCH) defined in the GSM specifications. At the same time the BTS makes measurements on the “uplink” signal level received from the MS. The two sets of measurements (from the MS and BTS) are combined by the BTS into a Measurement Report signalling message that is sent over the “A-bis” interface to the base station controller (BSC). The BSC uses these measurement reports to decide if a handover to a different serving cell is necessary. As the SACCH is a relatively low data-rate channel it takes a significant period of time for the MS to transmit its measurement results over the SACCH. Thus the BTS is making new measurements of uplink level for measurement period n+1 while it is receiving the MS's downlink measurements for the preceding measurement period n. The GSM specifications call for the BTS to report its uplink measurements for period n along with the MS downlink measurements for the same period n. Therefore the BTS is required to delay reporting of its own measurements for one measurement period while the MS measurements for that same period are received over the SACCH.

Another feature specified for the GSM air interface is the option of using Discontinuous Transmission (DTX). If the BTS or the MS has nothing to transmit (e.g. the corresponding party is not speaking) then no (or almost no) signal is transmitted on the Traffic Channel (TCH). The use of this option minimises potential interference from unnecessary transmissions and helps to conserve the MS battery. The use of DTX during a measurement period clearly affects the signal level measured by the receiving entity (MS for the downlink, BTS for the uplink). The GSM specifications address this problem by requiring the reporting of two signal levels: the first is a FULL level measurement made on the complete TCH; the second is a SUBSET level measurement made on mandatory transmission bursts not subject to DTX. The FULL level measurements are very accurate, as they are measured over all transmission bursts of the TCH channel. However, the FULL measurement will be wrong if DTX has been used on the TCH. The SUBSET level measurements are always valid, because they measure mandatory transmissions, but, as these mandatory transmissions are sparse, the SUBSET measurements are not necessarily very accurate.

To make best use of the uplink and downlink measurements the BSC must therefore know whether DTX has been used in the corresponding direction during the measurement period, so that it can select the FULL measurement (no DTX) or SUBSET measurement (DTX used) as appropriate. If DTX has been used on the downlink then the SUBSET level measurement from the MS should be used; if DTX has not been used on the downlink then the FULL level measurement from the MS should be used. Likewise, if DTX has been used on the uplink then the SUBSET level measurement from the BTS should be used; if DTX has not been used on the uplink then the FULL level measurement from the BTS should be used.

The MS includes with its downlink measurement reports sent over the SACCH a flag indicating whether it (the MS) has employed DTX on the uplink during that measurement period. This flag is called DTX-USED is the GSM specifications. Similarly the BTS includes with its uplink measurements (sent with the MS measurements to the BSC) a flag indicating whether it has used DTX on the downlink during the measurement period. This flag is called DTXd is the GSM specifications. As mentioned above, the GSM specifications call for the measurements made by the BTS to be delayed one period while the corresponding measurements from the MS are received. This is so that the downlink DTXd flag from the BTS is synchronised with the corresponding downlink measurement results from the MS, and the uplink DTX-USED flag from the MS is synchronised with the corresponding uplink measurements from the BTS. Hence the BSC can correctly select the FULL or SUBSET uplink and downlink measurements from each measurement report forwarded by the BTS to the BSC.

Although the primary intention of the measurement reports in a GSM system is to enable decisions on handovers between cells, these reports are useful for other purposes. For example, they can be non-intrusively collected from the A-bis interface by a link monitoring system and used in applications such as RF Quality of Service (QoS) monitoring, network optimisation, and calculating the geographic location of an MS.

However, the GSM specifications are open to interpretation and different equipment manufacturers can interpret the specifications in different ways. It has become apparent that BTS equipment from some equipment vendors does not delay the uplink measurements and downlink DTXd flag from the BTS until receipt of the corresponding downlink measurements and uplink DTX-USED flag from the MS. That is, the A-bis Measurement Report signalling message containing the MS downlink measurements and uplink DTX-USED flag for measurement period n contains the BTS uplink measurements and downlink DTXd flag for measurement period n+1. In consequence the selection of the FULL or SUBSET measurements may be incorrect, as the DTX flags reported are not for the same period as the measurement results. If the necessary delay of the BTS measurement is applied in the BSC (after transmission over the A-bis signalling interface), there will be no overall effect on the operation of the GSM network itself. Alternatively filtering and averaging in the BSC may mean that the only symptoms are some spurious handovers. However, for an A-bis monitoring system feeding a network optimisation or mobile location application this is likely to lead to erroneous results.

### DISCLOSURE OF INVENTION

According to one aspect of this invention there is provided a method of monitoring synchronisation of signal measurement reports in a mobile communications system, comprising:

monitoring signalling messages traversing a signalling link and containing measurement reports of signals exchanged by a base station and a mobile station;

deriving from the measurement reports a first indication of reporting of a first operational parameter of the exchanged signals;

deriving from the measurement reports a second indication of reporting of a second operational parameter of the exchanged signals; and

comparing the first and second indications to determine whether signal measurement reports are synchronised.

According to another aspect of this invention there is provided apparatus for monitoring synchronisation of signal measurement reports in a mobile communications system, comprising:

a monitor for monitoring signalling messages traversing a signalling link and containing measurement reports of signals exchanged by a base station and a mobile station;

an analyser for deriving from the measurement reports a first indication of reporting of a first operational parameter of the exchanged signals, and for deriving from the measurement reports a second indication of reporting of a second operational parameter of the exchanged signals; and

a comparator for comparing the first and second indications to determine whether signal measurement reports are synchronised.

### BRIEF DESCRIPTION OF DRAWINGS

A method and apparatus in accordance with this invention, for monitoring synchronisation of signal measurement reports in a mobile communications system, will now be described, by way of example, with reference to the accompanying drawings, in which:

FIG. 1 is a schematic illustration of part of a mobile telephone network incorporating equipment for implementing the invention;

FIG. 2 illustrates forwarding of measurement reports in a manner compliant with the GSM specifications;

FIG. 3 illustrates forwarding of measurement reports in a manner that is not compliant with the GSM specifications;

FIG. 4 is a block schematic diagram of a probe forming part of equipment for implementing the invention;

FIGS. 5A and 5B show a procedure for analysing the synchronisation of signal measurement reports; and

FIGS. 6A and 6B show a procedure for using this analysis to select an appropriate measurement report to be supplied to external applications.

### DETAILED DESCRIPTION

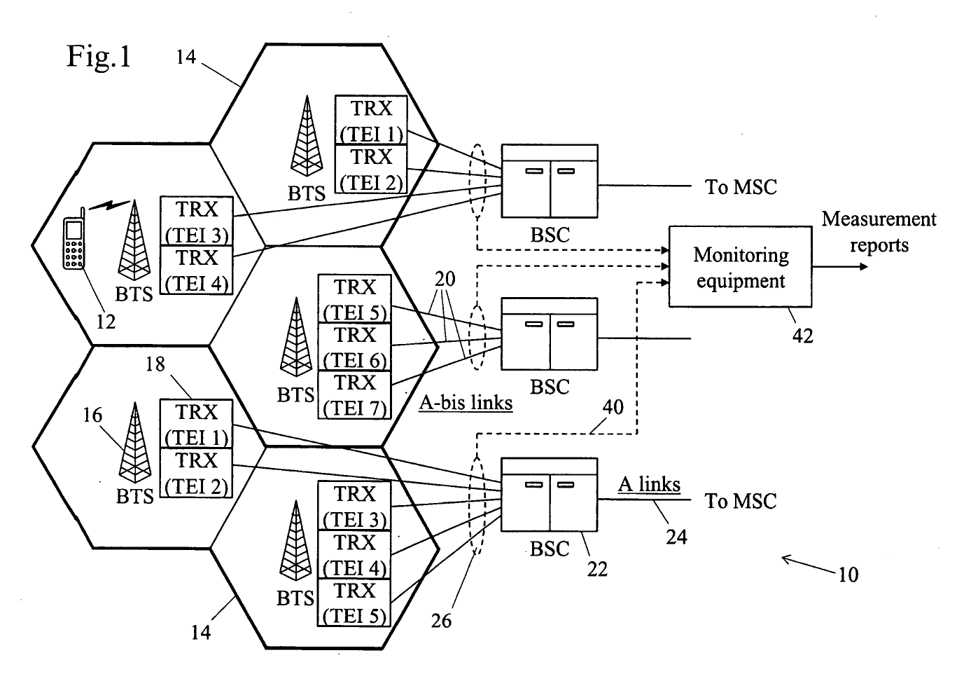

FIG. 1 shows major elements of a GSM cellular mobile telephone network 10 for communicating with a mobile phone handset (“mobile station”, MS) 12, with additional equipment to enable monitoring of synchronisation of measurement reports. For the sake of clarity the telecommunications transmission lines for carrying user voice and data signals are omitted; only the signalling links for control of operation of the network, which are of interest in the context of this invention, are shown.

Referring to FIG. 1, the mobile network 10 contains several cells 14, which are the basic unit of division of the coverage area for the purposes of radio spectrum management and are shown in FIG. 1 as conventional idealised hexagons. Each cell 14 contains a BTS 16 which houses one or more radio transceivers (TRXs) 18 for communicating with handsets over the radio “air interface”, and these transceivers are connected via “A-bis” signalling links 20 to a BSC 22 which may control transceivers in more than one BTS 16. The sub-system comprising a BSC 22 and its associated BTSs 16 is sometimes referred to as a base station system (BSS). The BSCs 22 are themselves co-ordinated via “A” signalling links 24 by mobile switching centres (MSCs, not shown).

During operation of the network 10, various operations are performed to control and measure the radio transmissions over the air interface between the MS 12 and the TRX 18. For example, the BTS 16 and the MS 12 each continually measure the strength and the quality (bit error rate) of the signal received over the air interface, and the MS 12 also measures the strength of signals being received (on the respective beacon frequencies) from BTSs 16 in neighbouring cells. The measurements made by the MS 12 are transmitted to the TRX 18, and the BTS 16 reports them with its own measurements over the A-bis link 20 to the associated BSC 22 for use in managing handovers of communications between cells in response to movement of the MS 12.

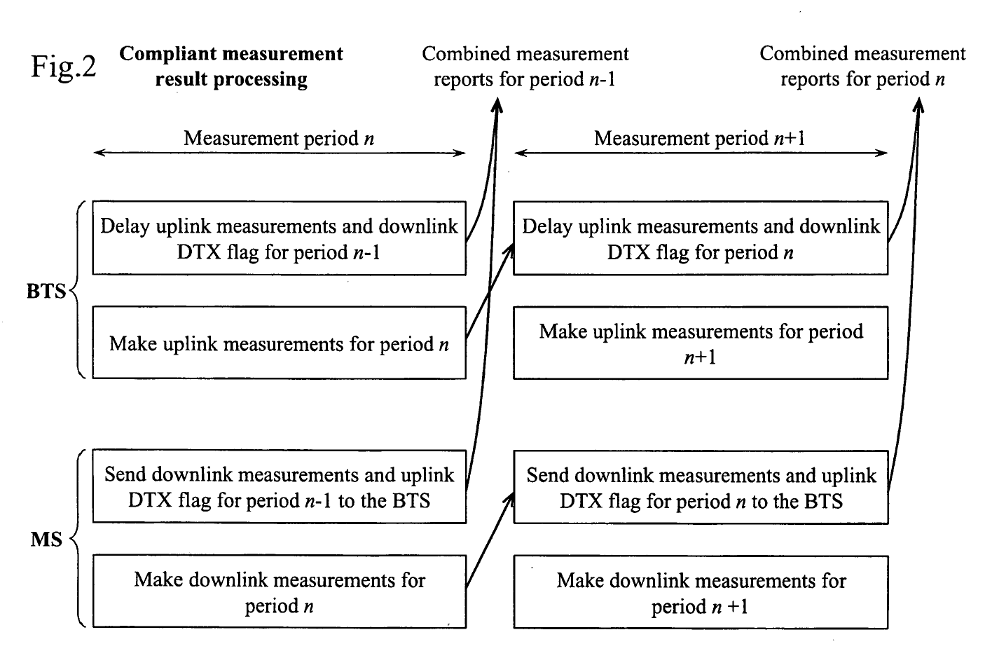

An active MS 12 makes the signal level and bit error rate measurements on the signal received from the serving cell, and reports them to the BTS 16 over the SACCH, every 480 ms (approximately). At the same time the BTS 16 makes measurements on the signal level received from the MS 12. The two sets of measurements (from the MS 12 and the BTS 16) are combined by the BTS 16 into a Measurement Report signalling message that is sent over the A-bis interface 20 to the BSC 22, again every 480 ms. The GSM specifications call for the BTS 16 to report its uplink measurements for period n along with the MS downlink measurements for the same period n. Therefore the BTS 16 is required to delay reporting of its own measurements for one measurement period while the MS measurements for that same period are received over the SACCH, as illustrated in FIG. 2. This is so that the downlink DTXd flag from the BTS 16 is synchronised with the corresponding downlink measurement results from the MS 12, and the uplink DTX-USED flag from the MS 12 is synchronised with the corresponding uplink measurements from the BTS 16.

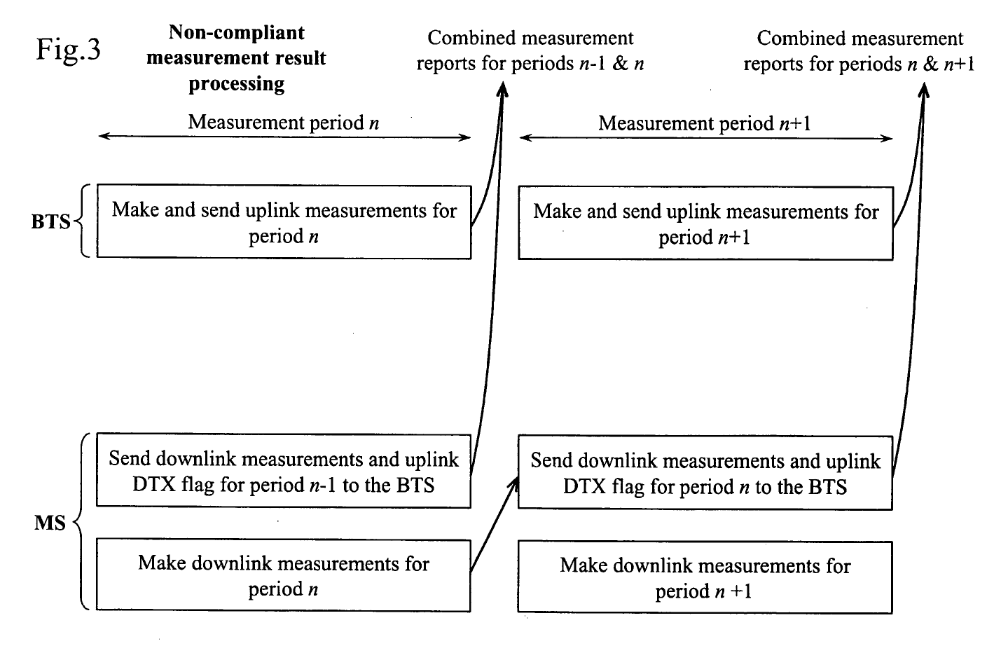

However, as noted above, BTS equipment from some equipment vendors does not delay the uplink measurements and downlink DTXd flag from the BTS 16 until receipt of the corresponding downlink measurements and uplink DTX-USED flag from the MS 12. Thus the A-bis Measurement Report signalling message containing the MS downlink measurements and uplink DTX-USED flag for measurement period n contains the BTS uplink measurements and downlink DTXd flag for measurement period n+1, as shown in FIG. 3. As mentioned above, this may cause erroneous results in link monitoring applications such as those for RF QoS monitoring, network optimisation and MS location.

One possible solution would be to design monitoring software such that the delay of such data is done in the monitoring software. That is, the downlink DTXd flag associated with measurement report n−1 would be used when deciding on selecting the FULL or SUBSET downlink measurements from measurement report n. Similarly, the uplink measurements from measurement report n−1 would be delayed and the uplink DTX-USED flag from measurement period n would be used to select the appropriate measurement. However, this requires knowledge of the compliance of the BTS 16 with the GSM specifications, so that the monitoring software can be configured to delay or not delay the uplink measurements and downlink DTXd flag appropriately. This information may not be known or available. Furthermore, it may differ among different BTSs monitored by the same monitoring system. Catering for such variation would require individual configuration of the uplink DTX delay processing for each monitored BTS, which would be difficult, time-consuming and expensive to maintain, and itself a potential source of errors.

This invention provides an A-bis link monitoring system and method for automatically discovering whether or not the uplink and downlink DTX flags are synchronised with the corresponding uplink and downlink measurements in Measurement Report messages on the A-bis interface. This auto-discovery may then used to select the correct FULL or SUBSET uplink/downlink level and bit error rate measurements from an A-bis Measurement Report message.

The monitoring system includes probes 26 (FIG. 1) for passively monitoring signalling messages traversing the A-bis links 20, as described below. The monitoring is passive in the sense that the operation of the links 20 is undisturbed by the presence of the monitoring system, which simply makes copies of some or all of the message packets it observes traversing the links. The probes 26 are coupled to the links in such a way that the operating characteristics of the links 20 are not significantly altered. In the case of an optical link, for example, the coupling may comprise an optical power splitter and for an electrical link it may be a bridging isolator.

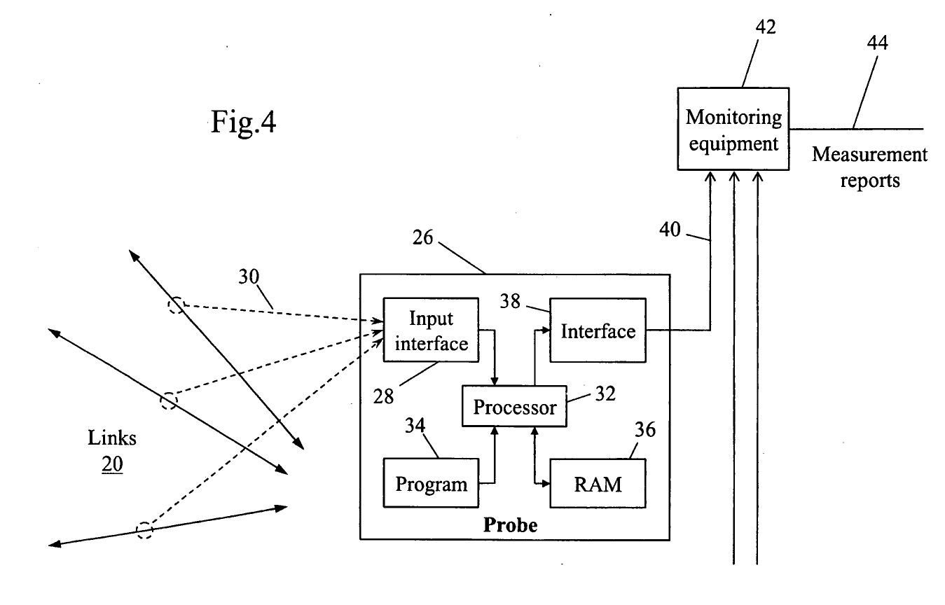

As shown in FIG. 4, each probe 26 has an input interface 28 which receives and conditions the signal received over a line 30 from the coupling to the relevant link 20 and which supplies the signal to a processor/CPU 32 operating under the control of software program instructions in a program store 34 and using a random access store 36. The processor 32 extracts messages from the signal and performs some initial processing (e.g. error checking and preliminary decoding). The messages are subsequently forwarded via an interface 38 and a communications bus 40 to monitoring equipment 42 for any necessary additional decoding and for further analysis as described below. This monitoring equipment provides a measurement report data output relating to active mobile stations on an output port 44. The probes 26 may comprise for example components of acceSS7 system equipment available from Agilent Technologies for monitoring messages traversing SS7 signalling networks.

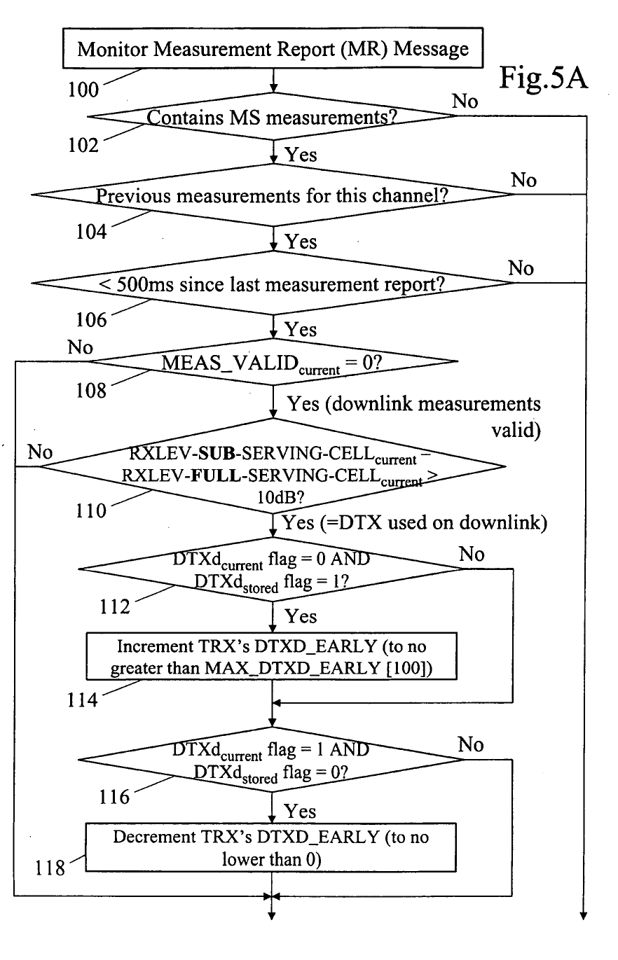

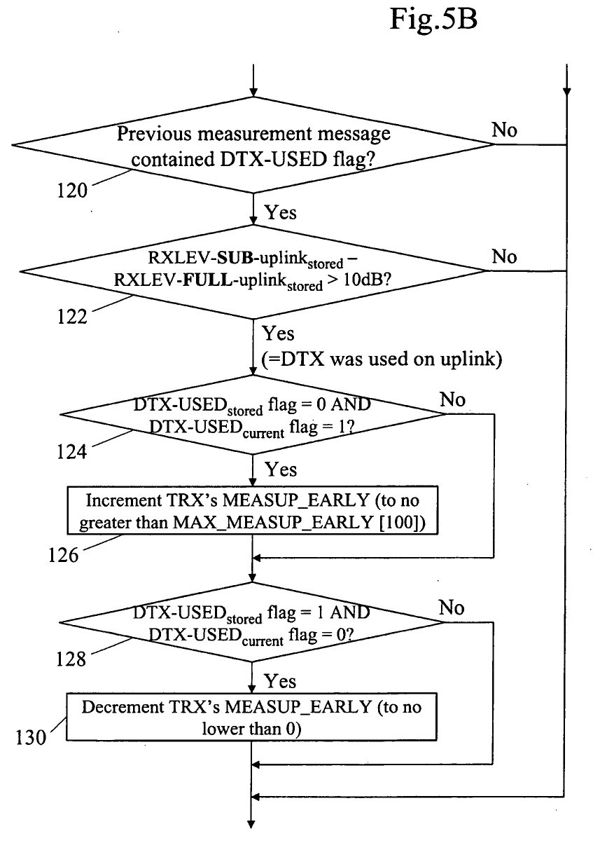

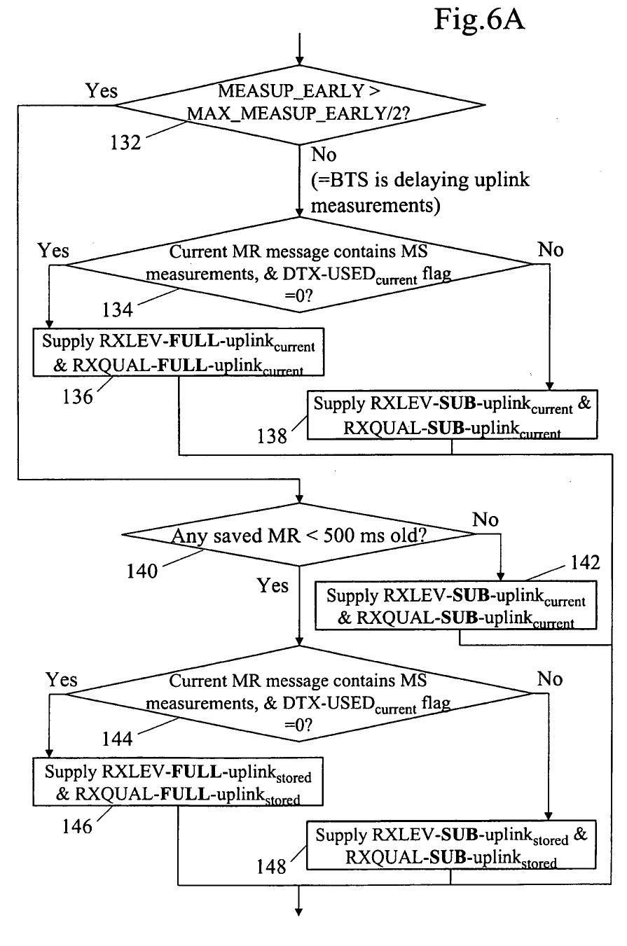

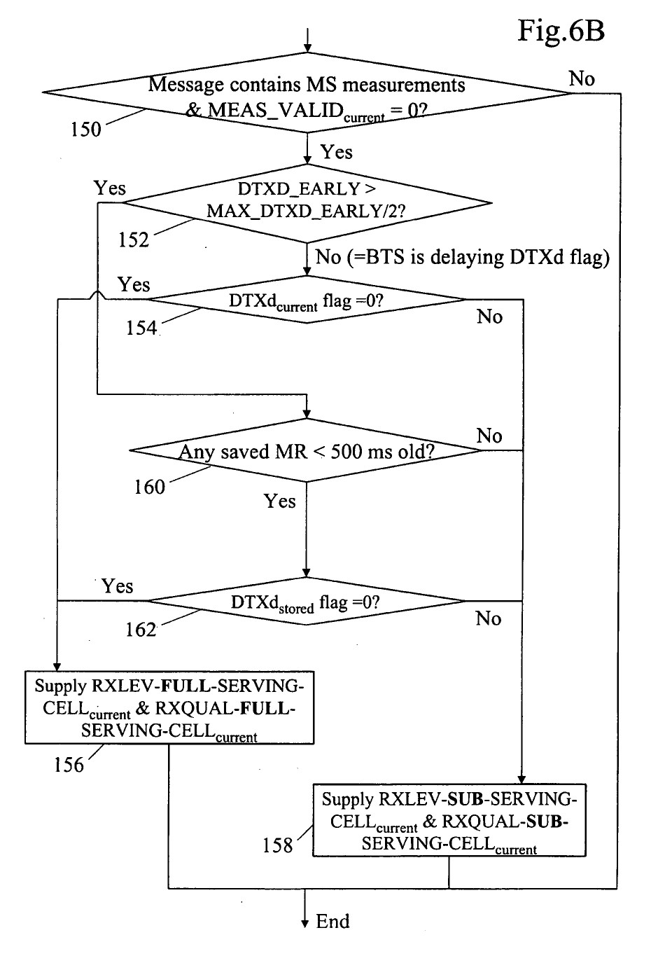

The procedure for discovering whether or not to delay the BTS uplink measurements and/or BTS downlink DTXd flag is shown in FIGS. 5A, 5B, 6A and 6B. This procedure requires the following specific supporting functionality:
Correlating signalling messages from the A-bis interface links 20 and associating Measurement Report messages from different MSs 12 with corresponding active channels. The key data for this correlation is the identification of the A-bis link and timeslot carrying the signalling message, the TRX Terminal End-point Identifier (TEI) and the A-bis channel number in the signalling message. Techniques for accomplishing this correlation are described for example in European patent application no. 1 304 897.
A store to hold details of the cells and TRX 18 being monitored by the monitoring system. The contents of this store may be set up manually or, preferably, automatically discovered from the link monitoring, for example using the methods described in U.S. Pat. No. 6,088,587.
A store for temporarily holding the last-received A-bis Measurement Report message for each call in progress. This store is indexed by the identification of the A-bis link and timeslot carrying the signalling message, the TRX TEI and the A-bis channel number in the signalling message. It may for example be implemented as an extension to existing data structures that are used for other call tracking purposes and that are indexed by these key data.
A store to record data to be used in determining whether or not each TRX 18 delays the downlink DTXd flag and/or uplink measurements. This store may be an extension to an existing TRX table. This tracking could also be done on a cell basis rather than a TRX basis, though implementing on a TRX basis allows for different behaviour by TRX within a cell. Two parameters to be stored here for each TRX 18 are:
   i) DTXD_EARLY: A “confidence” counter for holding values in the range 0 to MAX_DTXD_EARLY (equal, for example, to 100). If the counter value is in the range 0 to MAX_DTXD_EARLY/2 then this is indicative that the downlink DTXd flag has been delayed by the TRX 18 (i.e. the TRX is compliant with the GSM specifications) and need not be delayed in the monitoring software. If the value is in the range (MAX_DTXD_EARLY/2)+1 to MAX_DTXD_EARLY then this is indicative that the downlink DTXd flag has not been delayed by the TRX 18 and must be delayed in the monitoring software to compensate. This counter is set to 0 at system initialisation—giving a starting assumption that the TRX 18 does conform to the GSM specifications.
   ii) MEASUP_EARLY: A “confidence” counter in the range 0 to MAX_MEASUP_EARLY (also equal, for example, to 100). If the counter value is in the range 0 to MAX_MEASUP_EARLY/2 then this is indicative that the uplink level and bit error rate measurements have been delayed by the TRX 18 (i.e. the TRX is compliant with the GSM specifications) and need not be delayed in the monitoring software. If the value is in the range (MAX_MEASUP_EARLY/2)+1 to MAX_MEASUP_EARLY then this is indicative that the uplink level and bit error rate measurements have not been delayed by the TRX 18 and must be delayed in the monitoring software to compensate. The counter is set to 0 at system initialisation—giving a starting assumption that the TRX 18 does conform to the GSM specifications.

In the subsequent description the subscript _{current} refers to the data from a newly received measurement report and the subscript _{stored} refers to the data from the previous measurement report for the same active channel in the store. Steps 100 to 130 implement auto-discovery of whether the BTS 16 supplies delayed or early uplink DTXd flag and uplink measurements results. The remaining steps select the appropriate signal level and bit error rate measurements to supply to monitoring applications based on the discovered state.

Referring to FIGS. 5A to 6B, the procedure starts at step 100 by receiving an A-bis Measurement Report message. It is assumed that this measurement report has already been associated with an active channel by reference to the signalling link and timeslot on which the message was received, and the TEI and channel number in the message. If a test at step 102 ascertains that the message only contains measurements by the BTS 16 (no measurements from the MS 12) then the procedure skips the auto-discovery phase and advances straight to step 132, described below. It is possible for measurement results from the MS to become lost or corrupted on the air interface. In this case the BTS will still send its measurements over the A-bis interface.

If a test at step 104 shows that no previous measurement has been stored for this active channel (this is the first measurement report on the active channel) then again the procedure advances immediately to step 132. Likewise, a determination at step 106 that more than 500 ms have elapsed since the previous stored measurement report was received (i.e. a measurement report has been missed) results in a jump direct to step 132.

At step 108 a test is performed of the value of a parameter MEAS_VALID that is contained within the newly-received measurement report. If this value is not zero, indicating that the measurement is not valid, the procedure skips to a step 120 described below. Otherwise the procedure commences to assess the downlink measurement report provided by the MS 12, at step 110. First, a test is performed to determine whether the measurement report parameter RXLEV-SUB-SERVING-CELL_{current} (for the SUBSET downlink signal level measurement) exceeds the parameter RXLEV-FULL-SERVING-CELL_{current} (for the FULL downlink signal level measurement) by more than a configurable threshold, which may for example be 10 dB. If the SUBSET downlink measurement is not more than 10 dB above the FULL downlink measurement the procedure jumps to step 120. Otherwise the FULL downlink measurement is established to be much less than the SUBSET downlink measurement, so discontinuous transmission (DTX) must have been used on the downlink.

Therefore the procedure advances to step 112 to test whether the downlink DTXd_{current} flag is 0 and the DTXd_{stored} flag is 1. If this test is satisfied then at step 114 the DTXD_EARLY counter for the relevant TRX 18 is incremented (up to a limit of MAX_DTXD_EARLY). This is because a DTXd_{current} value of 0 indicates that the BTS is reporting that DTX was not used in the current measurement period. However, this conflicts with the determination just made at step 110 of DTX use, based upon a comparison of the FULL and SUBSET level values as measured by the MS. Since the BTS reported that DTX was used in the previous measurement period (DTXd_{stored} value of 1) it is likely that the BTS is failing to delay the DTXd flag in the measurement reports.

At step 116 another test is performed, of whether the downlink DTXd_{current} flag is 1 and the DTXd_{stored} flag is 0, in which case at step 118 the DTXD_EARLY counter for the relevant TRX 18 is decremented (down to a limit of 0). A DTXd_{current} value of 1 indicates that the BTS is reporting that DTX was used in the current measurement period. This is consistent with the determination at step 110 of DTX use, based upon comparison of the FULL and SUBSET level values as measured by the MS. The BTS reported that DTX was not used in the previous measurement period (DTXd_{stored} value of 0) so it is likely that the BTS is correctly delaying the DTXd flag in the measurement reports.

As a result of the operations performed at steps 114 and/or 118, over time the DTXD_EARLY counter will tend towards a value of zero if the BTS is correctly delaying the downlink DTXd flag, or tend towards a value of MAX_DTXD_EARLY if the BTS is, incorrectly, supplying the DTXd flag early.

At step 120 (FIG. 5B) a test is made of whether the previous saved Measurement Report message contained a DTX-USED flag. If not then the procedure jumps to step 132. This will happen if no downlink measurement results were received from the MS in the previous measurement period. Otherwise a test is made at step 122 of whether the RXLEV-SUB-uplink_{stored} (SUBSET uplink signal level measurement) parameter in the previous Measurement Report message exceeds the RXLEV-FULL-uplink_{stored} (FULL uplink signal level measurement) parameter by more than a configurable threshold, for example 10 dB. If the SUBSET uplink measurement is not more than 10 dB above the FULL uplink measurement the procedure jumps to step 132. Otherwise the FULL uplink measurement is determined to be much less than the SUBSET uplink measurement in the previous measurement report, so discontinuous transmission must have been used on the uplink when that measurement was being made.

Accordingly the procedure continues to step 124, to test whether the uplink DTX-USED_{stored} flag is 0 and the DTX-USED_{current} flag is 1. If this is the case, the MEASUP_EARLY counter for the relevant TRX 18 is incremented at step 126 (up to a limit of MAX_MEASUP_EARLY). A DTX-USED_{stored} value of 0 indicates that the MS reported that DTX was not used in the previous measurement period. However, this conflicts with the determination at step 122 of DTX use, based upon comparison of the stored FULL and SUBSET level values as measured by the BTS. The MS is reporting that DTX is being used in the current measurement period (DTX-USED_{current} value of 1); it is therefore likely that the BTS is failing to delay the uplink measurements in the measurement reports.

At step 128 there is a further test, of whether the uplink DTX-USED_{stored} flag is 1 and the DTX-USED_{current} flag is 0. If this test is satisfied then at step 130 the MEASUP_EARLY counter for the relevant TRX 18 is decremented (down to a limit of 0). The DTX-USED_{stored} value of 1 indicates that the MS reported that DTX was used in the previous measurement period. This is consistent with the determination at step 122 of DTX use, based upon comparison of the FULL and SUBSET level values for the previous measurement as measured by the MS. Since the MS reports that DTX was not used in the current measurement period (DTX-USED_{current} value of 0) it is likely that the BTS is correctly delaying the uplink measurements in the measurement reports.

As a result of the operations performed at steps 126 and/or 130, over time the MEASUP_EARLY counter will tend to towards zero if the BTS is correctly delaying the uplink measurement results, or tend towards MAX_MEASUP_EARLY if the BTS is, incorrectly, supplying the uplink measurement results early.

The following steps use the information thus gathered to guide selection of the appropriate measurements for use by external monitoring applications. First the uplink signal level and bit error rate measurements to be forwarded are selected. To this end, a test is made at step 132 (FIG. 6A) of whether the MEASUP_EARLY counter for the relevant TRX 18 has a value that is greater than MAX_MEASUP_EARLY/2. If the counter value is less than or equal to this threshold the BTS 16 is deemed to be delaying the uplink measurements as per the GSM specifications, and another test is performed at step 134, of whether the current Measurement Report message contains the MS measurements and the DTX-USED_{current} flag is 0. If both these criteria are satisfied then the RXLEV-FULL-uplink_{current} and RXQUAL-FULL-uplink_{current} (current FULL uplink measurements) parameters are supplied to external monitoring applications, at step 136; otherwise, at step 138, the RXLEV-SUB-uplink_{current} and RXQUAL-SUB-uplink_{current} (current SUBSET uplink measurements) parameters are supplied. The procedure then continues to step 150, described below.

If the test of the value of the MEASUP_EARLY counter at step 132 determines that the BTS 16 is not delaying the uplink measurements (as ought to be done for conformity with the GSM specifications) the stored previous measurements should be supplied at this time. First, however, a test is made at step 140 to confirm that there is a saved measurement report and that it is no older than 500 ms. If this test is not satisfied then the best that can be done is to supply the RXLEV-SUB-uplink_{current} and RXQUAL-SUB-uplink_{current} parameters, at step 142, and then continue with step 150.

If the test at step 140 is satisfied, the BTS 16 is not delaying the uplink measurements but a valid stored previous measurement is available. A further test is made at step 144, to confirm that the current Measurement Report message contains the MS measurements and that the DTX-USED_{current} flag is 0. If so, the previous RXLEV-FULL-uplink_{stored} and RXQUAL-FULL-uplink_{stored} (previous FULL uplink measurements) parameters are supplied to external monitoring applications, at step 146; otherwise the previous RXLEV-SUB-uplink_{stored} and RXQUAL-SUB-uplink_{stored} (previous SUBSET uplink measurements) parameters are supplied, at step 148.

The remaining selection to be made is of the downlink signal level and bit error rate measurements (made by the MS 12) to be forwarded. First a test is made at step 150 (FIG. 6B) to confirm whether the current MR message contains MS measurements and whether the MEAS_VALID parameter is 0 (indicating valid measurements). If not then no downlink level or bit error rate value is supplied, and the procedure ends immediately.

Otherwise a test is made at step 152, to compare the value in the DTXD_EARLY counter for the relevant TRX 18 with a threshold MAX_DTXD_EARLY/2. If the counter value is less than or equal to this threshold the BTS 16 is deemed to be delaying the downlink DTXd flag as per the GSM specifications, and another test is performed at step 154, of whether the DTXd_{current} flag is 0. If this criterion is satisfied then the RXLEV-FULL-SERVING-CELL_{current} and RXQUAL-FULL-SERVING-CELL_{current} (FULL downlink measurements) parameters are supplied to external monitoring applications, at step 156; otherwise, at step 158, the RXLEV-SUB-SERVING-CELL_{current} and RXQUAL-SUB-SERVING-CELL_{current} (SUBSET downlink measurements) parameters are supplied. The procedure then ends.

However, if the test of the value of the DTXD_EARLY counter at step 152 determines that the BTS 16 is not delaying the downlink DTXd flag (as should be done for conformity with the GSM specifications) then the DTXd flag from the stored previous measurement should be used at this time. First, however, a test is made at step 160 to confirm that there is a saved measurement report and that it is no older than 500 ms. If this test is not satisfied then the best that can be done is to supply the RXLEV-SUB-SERVING-CELL_{current} and RXQUAL-SUB-SERVING-CELL_{current} parameters, at step 158 as described above, and then end the procedure.

If the test at step 160 is satisfied, the BTS 16 is not delaying the downlink DTXd flag but a valid stored previous measurement containing the appropriate flag is available. A further test is made at step 162, to confirm that that the DTXd_{stored} flag is 0. If so, the RXLEV-FULL-SERVING-CELL_{current} and RXQUAL-FULL-SERVING-CELL_{current} (FULL downlink measurements) parameters are supplied to external monitoring applications, at step 156 mentioned earlier; otherwise the RXLEV-SUB-SERVING-CELL_{current} and RXQUAL-SUB-SERVING-CELL_{current} (SUBSET downlink measurements) parameters are supplied, at the afore-mentioned step 158. Thereafter the procedure ends.

1. A method of monitoring synchronisation of signal measurement reports in a mobile communications system, comprising:
monitoring signalling messages traversing a signalling link and containing measurement reports of signals exchanged by a base station and a mobile station;
deriving from the measurement reports a first indication of reporting of a first operational parameter of the exchanged signals;
deriving from the measurement reports a second indication of reporting of a second operational parameter of the exchanged signals; and
comparing the first and second indications to determine whether signal measurement reports are synchronised.

2. The method of claim 1, wherein the first operational parameter comprises received signal strength measurements made on two signal channels during a measurement interval.

3. The method of claim 1, wherein the second operational parameter comprises an indication of whether a signal was transmitted on one or both of two signal channels during a measurement interval.

4. The method of claim 2, wherein synchronisation of signal measurement reports is determined by
i) deducing from the received signal strength measurements an indication of whether a signal was being received on both of the two signal channels during the measurement interval;
ii) comparing that indication with the indication of whether a signal was transmitted on one or both of the two signal channels; and
iii) determining whether the compared indications relate to the same measurement interval.

5. The method of claim 1, wherein repeated comparisons of said first and second indications are made, and a counter value is incremented or decremented according to the result of each comparison.

6. The method of claim 5, wherein a determination of whether signal measurement reports are synchronised is made by comparing the counter value with a predetermined threshold value.

7. The method of claim 1, wherein selected measurement reports are supplied for further analysis, selection being made in accordance with the determination of whether the signal measurement reports are synchronised.

8. Apparatus for monitoring synchronisation of signal measurement reports in a mobile communications system, comprising:
a monitor for monitoring signalling messages traversing a signalling link and containing measurement reports of signals exchanged by a base station and a mobile station;
an analyser for deriving from the measurement reports a first indication of reporting of a first operational parameter of the exchanged signals, and for deriving from the measurement reports a second indication of reporting of a second operational parameter of the exchanged signals; and
a comparator for comparing the first and second indications to determine whether signal measurement reports are synchronised.
